(19) United States
(12) Patent Application Publication
(10) Pub. No.: US 2006/0075093 A1
(43) Pub. Date: Apr. 6, 2006

(54) Using flow metric events to control network operation

(75) Inventors: David Edward Frattura, New York, NY (US); Richard W. Graham, Derry, NH (US)

Correspondence Address: CHRIS A. CASEIRO, VERRILL DANA, LLP, ONE PORTLAND SQUARE, PORTLAND, ME, 04112-0586, US

(73) Assignee: Enterasys Networks, Inc., Andover, MA (US)

(21) Appl. No.: 10/958,761

(22) Filed: Oct. 5, 2004

(51) Int. Cl. G06F 15/173

(52) U.S. Cl. 709/224

(57) ABSTRACT

A system and method to monitor, detect, analyze and respond to, triggering conditions associated with packet and signal flows in a network system including attached functions and a network infrastructure. The system includes a detection function, an analysis function, and a response function. The detection function includes a monitoring sub-function, a flow definition sub-function, and a monitor counter sub-function. The flow definition sub-function defines the types of activities associated with the traffic flow that may indicate a triggering condition requiring analysis and potentially a response. The monitor sub-function observes traffic flows. The monitor counter sub-function counts the defined types of activities occurring in the device. The analysis function analyzes the event from the monitored flows, flow counters, status and other network information and determines whether a response is required. The response function initiates a response to a perceived event or attack based on the events detected in the flow metrics and other data. The response function further includes a sub-function for activating changes throughout the network system based on receiving and sending event notifications. Responses generated by the response function include dynamic policy changes.

### BACKGROUND OF THE INVENTION

1. Field of the Invention

The present invention relates to methods and systems for detecting and mitigating the effects of flow anomalies in a network communication system. More particularly, the present invention relates to methods and systems for defining and monitoring flow conditions, analyzing the conditions, and reacting in ways to improve network security, usefulness and efficiency. As an example, the system would discard or dampen excess packet flows to minimize the impact of denial of service attacks and to prevent or minimize their effects on data networks. These methods and system functions are expected to be used within a one or more network infrastructure device and also coordinated across many diverse network system devices.

2. Description of the Prior Art

Interconnected computing systems having some sort of commonality form the basis of a network. A network permits communication or signal exchange among computing systems of a common group in some selectable way. The interconnection of those computing systems, as well as the devices that regulate and facilitate the exchange among the systems, represent a network. Further, networks may be interconnected together to establish internetworks. For purposes of the description of the present invention, the devices and functions that establish the interconnection represent the network infrastructure. The users, computing devices and the like that use that network infrastructure to communicate are referred to herein as attached functions and will be further defined. The combination of the attached functions and the network infrastructure will be referred to as a network system.

Presently, access to applications, files, databases, programs, and other capabilities associated with the entirety of a discrete network is restricted primarily based on the identity of the user and/or the network attached function. For the purpose of the description of the present invention, a “user” is a human being who interfaces via a computing device with the services associated with a network. For further purposes of clarity, a “network attached function” or an “attached function” may be a user connected to the network through a computing device and a network interface device, an attached device connected to the network, a function using the services of or providing services to the network, or an application associated with an attached device. Upon authentication of the offered attached function's identity, that attached function may access network services at the level permitted for that identification. For purposes of the present description, “network services” include, but are not limited to, access, Quality of Service (QoS), bandwidth, priority, computer programs, applications, databases, files, and network and server control systems that attached functions may use or manipulate for the purpose of conducting the business of the enterprise employing the network or might otherwise provide or use data or information transfer. The basis upon which the network administrator grants particular permissions to particular attached functions in combination with the permissions is an established network usage policy. For example, one policy may be that any user (one type of attached function) with an employee identification number is granted access to the enterprise's electronic mail system at a specified bandwidth and QoS level.

Events and activities do occur that may be harmful to the network system. For purposes of this description, harm to the network system includes, for example, denying access to the network, denying access to the services of the network, unauthorized access to the services of the network, intentionally tying up network computing or data relay resources, intentionally forcing bandwidth availability reduction, and restricting, denying or modifying network-related information. There are currently two generally available forms of network protection designed to minimize such types of network harm: firewalls and an Intrusion Detection Systems (IDS). Firewalls monitor, analyze and enforce all in one, and are designed to prevent the passage of packets to the network based on certain limited specific conditions associated with the packets. Firewalls do not permit packet passage for the purpose of further analysis nor do they enable assigned policy modifications.

IDSs typically only monitor traffic. They do not analyze nor do they enforce. They are generally more effective at monitoring/detecting potentially harmful traffic than are firewalls. They are designed to observe the packets, the state of the packets, and patterns of usage of the packets entering or within the network infrastructure for harmful behavior. However, until recently with the availability of the Distributed Intrusion Response System by Enterasys Networks of Andover, Mass., common owner of the invention described herein, the available IDSs do not prevent packet entry to the network infrastructure. Further, for the most part, they only alert a network administrator to the existence of potentially harmful behavior but do not provide an automated response to the detected occurrence. There is some limited capability to respond automatically to a detected intrusion. However, that capability is static in nature in that the response capability is ordinarily restricted to limited devices of the network infrastructure and the response is pre-defined and generated by the network administrator for implementation on specified network infrastructure devices.

For the most part, existing IDSs, whether network-based (NIDS), host-based (HIDS) or a combination of the two (NIDS/HIDS), report possible intrusions to a centralized application for further analysis. That is, all detected potentially harmful occurrences are transferred to a central processing function for analysis and, if applicable, alarm reporting. The detection functionality may reside in one or more appliances associated with one or more network devices. Each appliance provides its own report to the central processing function with respect only to those packets passing through it. The central processing function then conducts the analysis and the alarm reporting. Network administrators often restrict the intrusion detection functionality to certain parts of the network system rather than to the entirety of the system. That is, for example, all packets entering a network infrastructure from an attached function may be forced to enter through one or more select entry functions. Those select entry locations form a choke point or bottleneck arrangement in the network. IDS and their placements are typically chosen for throughput capacity and to simplify manual policy changes that may be required based upon an alarm occurrence.

Upon receipt of an alarm, the network administrator can either do nothing, or implement a response function through adjustment of the operation of one or more network infrastructure devices. The implementation of a response function may take a relatively significant amount of time, with the response delay, or latency, potentially allowing greater harm to, or at least reduced effectiveness of, the network system prior to the implementation of a response to address the triggering activity or event. In a network system in which only a select few network infrastructure devices have intrusion response functionality, the implemented response may result in more widespread restriction of network usage than may be warranted by the triggering activity or event. The response may also be excessive if a greater number of network infrastructure devices are configured to respond to an attack than the scope of the intrusion warrants. It would be preferable to have a response capability that is implementable as quickly as possible in a manner that substantially ensures repulsion/neutralization of a triggering activity or events, such as an attack, while the system goes through the process of establishing a revised set of policies to specifically address the activity or events only, and in a manner targeted at only the source of the attack.

As indicated, other than the Enterasys Distributed Intrusion Response System, the presently available IDSs only report the existence of potentially harmful activities, events or occurrences, and do not enable responsive policy modification. Any adjustment to the state of permitted attached function network usage typically occurs manually after detection and evaluation on an ad hoc basis. Therefore, what is needed is a network function arranged to produce a rapid response to a detected flow condition or event through changes in the operational features or policies of one or more network infrastructure devices. The one or more network infrastructure devices for which a change is effected may or may not be directly associated with the detected condition or detection location.

Importantly, the ability to respond in an organized manner to distributed attacks is currently very limited. For purposes of this discussion, a distributed attack is one in which a plurality of network system devices are included in the activity. A network system having network intrusion detection “protection” may nevertheless be harmed by a distributed attack. That is, individual network infrastructure devices may not be compromised in their operation, but a plurality of network system devices may be used in combination to compromise a specific network system device or affect the system bandwidth available for use. An example of a distributed attack is the SQL Slammer. By the time the network administrator recognizes the nature of the distributed attack, it may be too late to implement policy changes on the individual network system devices associated with the distributed attack. Therefore, what is needed is a response system capable of effective detection and response to distributed attacks.

A detrimental effect of a DOS attack is the consumption of a substantial portion of available bandwidth in the network. In some instances, the network devices may have adequately protected control functions that are not impacted by a DOS attack. The problem occurs in the fact that such devices will not degrade or fail but that they will instead continue to forward the harmful traffic, in effect facilitating the infection of other network or infrastructure devices and attached functions of the network system. That, in turn, causes a greater consumption of network bandwidth until enough signal forwarding devices are involved and generate enough data network traffic in total such that valid traffic may no longer be forwarded effectively on the network links.

Another intentional activity harmful to network system operation is the port scan. Port scans are computer programs configured by hackers to learn about the interior of a data communication network as well as vulnerabilities in a data communication system. A port scan uses valid network protocol mechanisms where one data communication system establishes communication with another system. Attempted communications by opening both Transport Control Protocol (TCP) and Uniform Datagram Protocol (UDP) “ports” from 1 to 65000 is a typical approach used in a port scan. In this process, it is the intent of the hacker that the communication system being probed will respond to the probing station each time port is opened, indicating the presence of that port. It is by learning which ports are present that a hacker can potentially determine the device type and the system's vulnerability to attack. In addition, these scans and responses may consume a fair amount of bandwidth.

A firewall or IDS function may be useful in detecting such events. The information that they provide must be analyzed by a central processor and a response implemented through one or more signal forwarding functions. That process takes time and may consume more network system resources than may be required to respond to the distributed scanning event. It would be preferable to take advantage of the existing functionality of signal and packet forwarding devices to detect and/or respond to this type of scanning process and other triggering events.

Therefore, what is needed is a method and related system to detect, notify, and/or respond to, triggering events quickly and effectively. Further, what is needed is such a method and related system that provides for such capability through existing network signal forwarding devices capable of making normal forwarding and traffic classification decisions. The method and related system preferably operate within the confines of the existing network infrastructure in a localized manner so as to minimize the impact on the remainder of the network that may not be affected by the triggering conditions or events. Further, the system and methods are preferably scalable to operate across multiple devices to provide efficient DOS and other event detection and prevention.

### SUMMARY OF THE INVENTION

The present invention is a method and related system to detect, notify, analyze and/or respond to, triggering flow metric conditions or events quickly and effectively. The invention preferably operates within the confines of the existing network infrastructure in a localized manner so as to minimize the impact on the remainder of the network that may not be affected by the triggering conditions or events. The invention takes advantage of many of the existing classification and flow metrics instrumentation capabilities of network infrastructure routing/switching devices. The invention also takes advantage of the existing capability of network devices and systems that track signal exchanges in the form of flows (a logical representation of communication between or among attached functions) to identify the presence of a threat (potentially harmful activity) to the communication system. The method and related system of the present invention provides several response mechanisms to mitigate the threat and to alarm network administrators of the presence of detected conditions, activities, and events. For purposes of describing the present invention, it is to be understood that flows in a data network can be thought of as the signal or packet flows or logical “conversations” between devices of the network system, functions attached to the network system, or combinations thereof. Flows may be further defined at many levels such as, for example, all traffic between any two MAC addresses, or all traffic from a single IP server based on its IP (layer 3) address. Flows may be unidirectional or bi-directional, they may use any fields or data in the data packets to determine or help determine flow definition. Further, flow metrics are the status, timing and history based data, and derived information about any specified flow or flows. Flow metrics may include information about only a specific flow, or may use information from multiple flows and other data available or derived from the flows, or network's status or events and other information. A flow metric event is the occurrence of a condition determined by a set of parameters, including flow metrics, defined to be of interest or to be monitored by the network system. While always including flow related information, these flow metric events might include any other network data, status or related or relevant information. As an example, a flow metric event could be defined to be triggered if the aggregate flows egressing a single backbone port “M” exceed value “X” between 8:00 AM and 5:00 PM, and value “Y” all other times except if redundant port “N” is in use. It is easily understood that there is a wide variety of ways to define specific signal or data flows, and a very wide variety of parameters and status and conditions which could aid in defining a vast set of flow metric events. Of particular interest, is the use of those flow metric events that are indicative of network harm and the ability of the analysis and response function to generate mitigating changes in network access and use.

The present invention employs existing forwarding device knowledge and control and management functions to detect changes in the flow metrics which may indicate harmful or potentially harmful activity. The communication of this flow metric event information, coupled with an analysis function, enables a policy change by a centralized system, a localized response by the reporting device(s), and/or distributed response by other forwarding devices.

In one example of the method of the present invention, anomalies in the flow metrics are detected in a network system by monitoring the rate of data flow creation, flow counts and analyzing the traffic patterns in the flows. Many network infrastructure devices forward traffic based on a flow definition, or they monitor network level conversations with flow-based tracking. The invention is configured to detect conditions or events, such as excessive flow creation rates, based on attached-function-to-attached-function exchange protocols at any of the layers of the OSI model. The invention then provides for adjustment of network device operation through defined remediation policies based on where the events were detected and/or other status and/or network data.

The system of the present invention includes three primary functions. The first is a Detection Function. The Detection Function preferably includes a set of sub-functions used to monitor flow metrics for critical triggering events as indications of network system threats. When a threat pattern is detected, the Detection Function triggers notification of the event to an Analysis Function. Outputs from the Analysis Function are typically implemented or “enforced” by a Response Function. The Response Function preferably includes a set of sub-functions to generate various network operation outcomes responsive to the signals or packets indicative of harmful or potentially harmful activity. These Response Functions may be enabled on a per device, per channel, per port, per set of channels, per set of ports, or per set of devices arrangement. Further, the functions may be operable in a format compatible with IEEE 802.1 Q Virtual LAN service, IEEE 802.11 Wireless LAN service, and WAN/MAN switch routers with channelized interfaces. In a generalized network wide model, the Response Function may provide enforcement through a Policy Management driven distribution and rule based enforcement model.

The method of the present invention involves the following steps, all or a portion of which may be used to establish an attack monitoring and response functionality. The steps include monitoring the network system for flow metrics events, analyzing the monitored flow metric events and other information, and generating a response deemed responsive to any analyzed flow metric events and other information determined to require a response. In another aspect of the method of the present invention, steps include: 1) establishing a flow definition for each monitored flow, 2) monitoring one or more flows associated with the operation of the network system, 3) associating each flow definition with a flow counter, wherein the flow counter generates count information for the flow definition, 4) defining particular count information or other events as a triggering condition (or conditions), 5) upon determining that a triggering condition exists, generating a notification to the analysis function, 6) analyzing the flow event(s) and potentially other information, and 7) generating a response by changing one or more policies associated with one or more network infrastructure devices, one or more attached functions, or both.

The related system for implementing the present invention includes a Detection Function for monitoring defined flows associated with the network system, and detecting defined triggering conditions, and a Response Function for responding to triggering conditions defined to require a response and implementing a change of condition of the network system. The system may also further include an Analysis Function. In another aspect of the invention, the system includes: 1) a monitor sub-function for monitoring flows associated with the network system, 2) a flow definition sub-function for defining activity types to be monitored, 3) a monitor counter sub-function for counting the defined activity types, 4) a notification sub-function for initiating a notification in the network system to a monitored flow based on a count or other metrics of a defined activity type, 5) analysis of the notification(s) and 6) a response function for responding to the response function by triggering a change of condition of the network system including not only what is monitored but what is forwarded or none or both.

In an aspect of the invention, there is an article of manufacture comprising a machine-readable medium that stores executable instruction signals that cause a machine to perform the method described above and related methods described herein.

The details of one or more examples related to the invention are set forth in the accompanying drawings and the description below. Other features, objects, and advantages of the invention will be apparent from the description and drawings, and from the appended claims.

### DESCRIPTION OF DRAWINGS

FIG. 1 is a simplified diagrammatic block representation of an example network system with the detection, analysis and response system of the present invention.

FIG. 2 is a simplified flow diagram of the system process of the present invention.

FIG. 3 is a simplified block representation of the interconnection of network infrastructure devices and attached functions, the infrastructure devices including attack detection, analysis and response functions.

FIG. 4 is a simplified representation of an example signal exchange in a network system, showing a first type of flow to be monitored.

FIG. 5 is a simplified representation of an example signal exchange in a network system, showing a second type of flow to be monitored.

FIG. 6 is a simplified representation of an example signal exchange in a network system, showing a third type of flow to be monitored.

### DETAILED DESCRIPTION OF PREFERRED EMBODIMENTS OF THE INVENTION

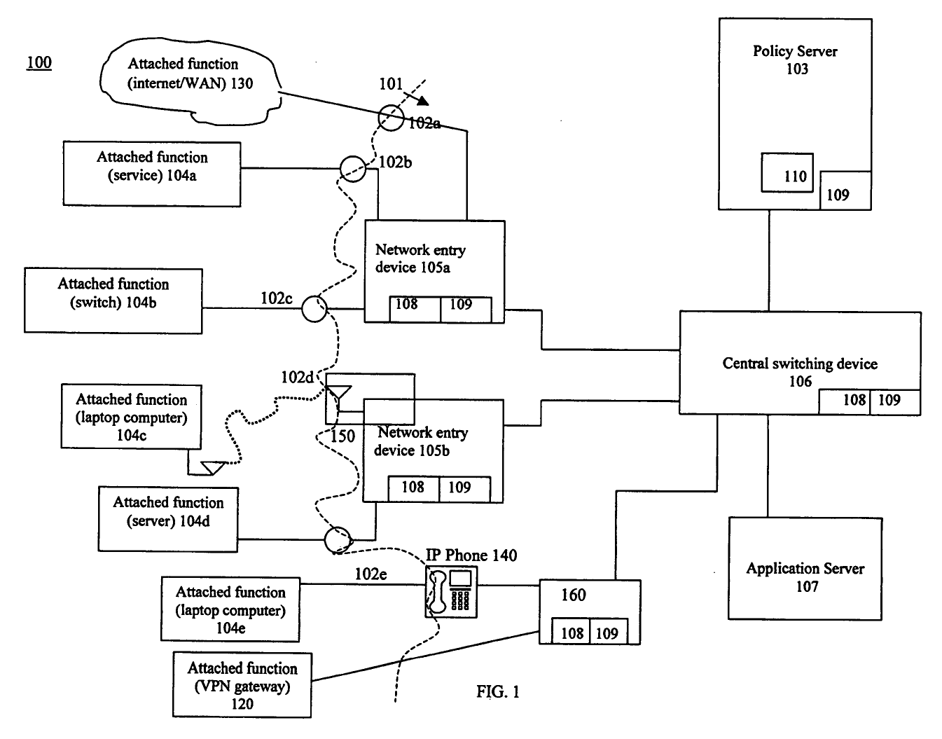

The present invention is a system and related method to detect through one or more network infrastructure forwarding devices potentially or actually harmful activity in network system packet or signal traffic. The detected information is analyzed and reported to a centralized or distributed policy management and enforcement function, acted upon by the detecting device or devices, or a combination of the two. Generally, the system provides a method for using flow metrics to determine whether operation of a portion or all of a network system should be adjusted, such as through dynamic policy changes, based on a triggering condition. Referring to FIG. 1, a network system 100 incorporating the capabilities of detection, analysis and response to triggering events based on flow metrics is shown. A simplified version of the system of the present invention is a typical local (all the functions in a single device) implementation that merely detects a predetermined flow condition and implements simplified directed response. This implementation either eliminates or greatly simplifies the analysis function. This simplified version is referred to as the Flow Metrics Detection and Response System or DRS. Network system 100 includes a network infrastructure 101 and one or more attached functions connected to or connectable to the network infrastructure 101. The network infrastructure 101 includes multiple switching devices, routing devices, firewalls, access points, MANs, WANs, VPNs, and internet connectivity interconnected to one another and connectable to the attached functions by way of connection points (e.g., 102a-e). The DRS of the invention employs both hardware and software (e.g., a function embodied in an application executing on server 103) to detect potentially harmful activity associated with the transfer operations of the network infrastructure devices and adjust those operations in response as will be further described.

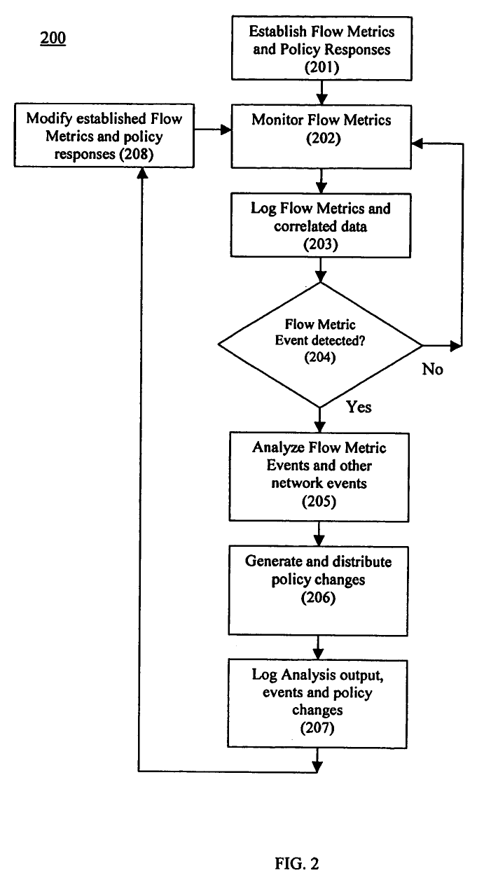

With reference to FIG. 2, the system process of the present invention is described in flow form in process 200 and includes a plurality of steps designed to detect events and respond to such events if it is deemed necessary to do so. A step of the process 200 includes establishing flow metrics and applicable dynamic policy responses (step 201). Flow metrics have been defined herein, and examples are provided. The dynamic policy responses are any deemed suitable by the network administrator, including those provided manually and those further defined herein. Examples of some types of policy responses are described in co-pending U.S. patent application Ser. No. 10/629,331 entitled “System and Method for Dynamic Network Policy Management” of John Roese et al. and assigned to a common assignee. The entire content of that co-pending application is incorporated herein by reference. Examples of triggering conditions or events that may also result in such dynamic policy changes are noted herein and provided in additional detail in the referenced co-pending application of John Roese et al.

The process 200 includes the step of monitoring the network system for the flow metrics that have been established (step 202). The monitored flow metrics information is preferably recorded and, if desired, correlated with other flow metric and/or network system information (step 203). The system determines whether one or more flow metric triggering conditions or events have been detected by the monitoring step (step 204). If not, the monitoring continues without further activity. If a triggering flow metric condition has been detected, an Analysis Function analyzes the condition and, optionally, other events or network system information, for the purpose of determining the form of a response to be initiated, if any (step 205). The process 200 further includes the step of generating and distributing to one or more devices of the network system one or more policy changes based upon the analysis (step 206). The analysis, policy change decision, the triggering condition, and any outcomes may be logged (step 207). If it is deemed necessary or useful, the established flow metrics, responses, or combinations thereof, may be modified (step 208) and the process continued. Although the process 200 may be performed sporadically or periodically, it is preferably performed substantially continuously. Further the steps may be implemented in multiple devices and configured to provide communications among the steps running in parallel, serial or altered order but so as to implement the general process.

Referring again to FIG. 1, an attached function is external to infrastructure 101 and forms part of network system 100. Examples of attached functions 104a-104e are represented in FIG. 1, and may be any of the types of attached functions previously identified. Network infrastructure entry devices 105a-b and switch 160 of infrastructure 101 provide means by which the attached functions connect or attach to the infrastructure 101. A network entry device can include and/or be associated with wireless connectivity (e.g., wireless access point 150). For the wireless connection of an attached function to the infrastructure 101, a wireless access point may be used to establish that connection. It can be an individual device external or internal to a network entry device. A central switching device 106 enables the interconnection of a plurality of network entry devices as well as access to network services, including server 103. The central switching device 106 or any other type of signal transfer device, further enables the interconnection of the network infrastructure 101 to attached functions that include WANs (represented by internet cloud 130), VPN gateways (represented by device 120), as well as firewalls and IDSs connectable to the attached functions.

One or more of the devices of the infrastructure 101 may include one or both of a Detection Function module 108 and a Response Function module 109. For purposes of illustration, network infrastructure devices 105a, 105b, 106, and 160 each includes the Detection Function module 108 and the Response Function module 109, while server 103 includes the Response Function module 109. It is to be understood that any of the forwarding devices of the network infrastructure 101 may include either or both of modules 108 and 109. Additionally, server 103 may also include both but preferably includes Response Function module 109. Further, it is to be noted that either or both functions may be configured on a per device or per port/channel basis. It may include one or more of the detection sub-functions to be described herein, as well as command and communication functions of the type generally associated with network operation servers. It is to be understood that in a comprehensive network infrastructure, not all signal transferring devices may include the functionality embodied in the two modules. Any network infrastructure device including the module 108 will be referred to herein as a network detection device and any network infrastructure device including the module 109 will be referred to herein as a network response device. Further the Analysis Function (110) preferably implemented in a server (such as 103) may also be located in either detection or response devices, in whole or in a limited form. These functions are capable of communicating with all other functions in all devices. The communication capability may take many forms with SNMP to be used in a preferred embodiment.

The Detection Function may configured on network infrastructure devices through any of a number of well known means. Preferably, a detection function template is created and employed to configure all defined parameters for each sub function described herein. Similarly, the Response Function is configured on selected devices using a response function template. The two templates are interactive in that one or more defined pointers of one point to conditions to be activated in the other. Module 108 includes one or more of the four sub-functions. The four sub-functions are: a) a monitor sub-function; b) a flow definition sub-function, c) a monitor counter sub-function and d) a notification sub-function. The monitor sub-function associates new traffic flows with the address of a particular network infrastructure device. The flow definition sub-function defines the traffic flow for the associated network infrastructure device. The monitor counter sub-function establishes flow creations and counts active exchanges associated with identified flows. The notification sub-function initiates communication to the analysis function or response function based upon flow metric triggering events. The Analysis Function, which performs the function of analyzing the flow event information, such as flow metrics, including count information, determines whether a response, such as a filter or dynamic policy change, is to be implemented. The Analysis Function is particularly useful where harmful network activity such as DOS attacks can typically be determine only by analyzing data and events from more than one device or detection function. Any of the functions may exist or be implemented on one or more devices of the network system. They may be located in central devices, network entry devices or servers. Any one or more of the functions may be centralized or distributed or implemented in a redundant manner.

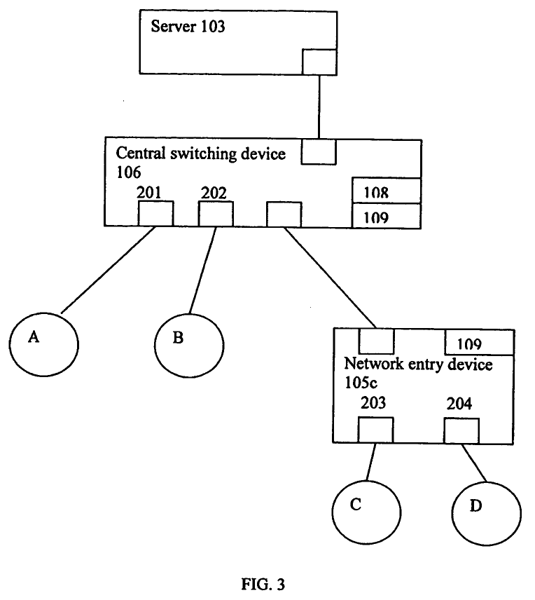

The monitor sub-function associates the flow metrics for attached functions with one or more specific network infrastructure devices of the network system 100 whether, the attached functions monitored are directly or indirectly attached to the particular network infrastructure device used for the association. For example, as illustrated in FIG. 3, attached functions A and B may be connected directly to ports 201 and 202, respectively, of central switch device 106. On the other hand, attached functions C and D may be connected directly to ports 203 and 204, respectively, of network entry device 105c, which is in turn connected directly to central switch device 106. Therefore, attached functions C and D are connected indirectly to central switch device 106. In this representation, the network entry device 105c does not have the module 108 but it does have the module 109. The central switch device 106 does include the module 108 as well as the module 109. In general, any network infrastructure device preferably includes the module 109, but is not required to have one. Instead, the response function to be described herein may be communicated from a core network infrastructure device to a network entry device or central switch device to enable the response function to be configured for a particular port or ports of either such device. The type of addresses monitored may be selectable as a function of the particular communication protocol(s) associated with the network.

The monitor sub-function of the Detection Function establishes the basis for determining the characteristics of a particular flow under monitor for potentially harmful activity. The present invention is directed to evaluating network traffic for potentially harmful activity by monitoring for unusual flow events. Such events may be generated by a particular attached function, they may be directed to a particular attached function, or they may relate to an exchange between two or more attached functions. The events may also involve a particular network infrastructure device. For these reasons, the monitor sub-function may be associated with the source address or destination address of an attached function or a network infrastructure device involved in a flow under monitor. It may also be associated with a bilateral address pair involved in a flow under monitor; that is, a source address/destination address pair. Further, it may be associated with the ingress and/or egress ports of a network infrastructure device, as well as system aggregate flows, port group ingress aggregates, channel group ingress aggregates, port group egress aggregates, channel group egress aggregates, port-to-port flows, and channel-to-channel flows. A few will be described herein; however, it is to be understood that the system administrator may set up to monitor any sort of flow to be examined for triggering events or conditions.

The source address monitor sub-function is a monitor function that examines only the flows in the network system generated by a particular attached function. The source address monitor sub-function may be enabled to monitor communications traffic on a port by port basis, or from a system wide point of view. When implemented on a system wide basis, the data flows are monitored for all ports in the system simultaneously. In certain situations, such as when the ingress port on a network infrastructure device where the monitor sub-function is to be enacted is a link aggregated port (IEEE 802.3AD interface), the network system must correlate events across multiple ports into a single match result when received packets match a source address monitor definition.

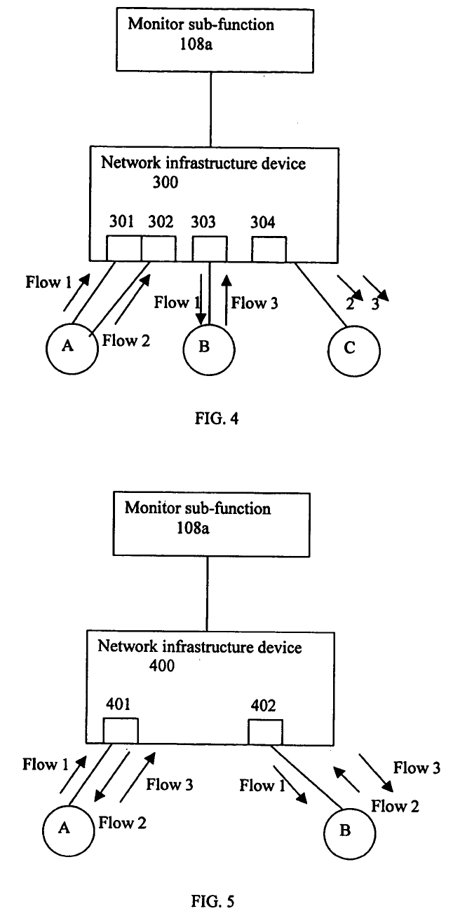

To illustrate the flow types associated with the source address monitor sub-function with reference to FIG. 4, a generic network infrastructure device 300 associated with a monitor sub-function module 108a of the module 108 and including ingress ports 301, 302 and 303, and egress ports 304 and 305, is connected to attached functions A, B, and C. Flow 1 represents the transfer of signals from attached function A to attached function B, Flow 2 represents the transfer of signals from attached function A to attached function C, and Flow 3 represents the transfer of signals from attached function B to attached function C. The flows may be classified in any of three ways. First, by source address alone, second, by ingress port and source address, and third by system-wide aggregation. In respect of the first source address monitor option for the connection arrangement of FIG. 4, source address A for attached function A has two flows, Flow 1 and Flow 2, source address B for attached function B has one flow, Flow 3, and source address C for attached function C has no flows. In respect of the second source address monitor option, port 301 has one flow, Flow 1, and port 302 has one flow, both for attached function A, while port 303 has one flow, Flow 3, for attached function B. In respect of the third source address monitor option, there is a set of three source address based flows for the aggregate system, Flows 1-3.

There are multiple uses of a source address monitor sub-function, in data communication networks utilizing Internet Protocol version 4 (IPv4). The source address monitor sub-function may be used to detect port scans, virus-initiated attacks (such as SQL-Slammer) or network ICMP spray attacks. The source address monitor sub-function also enables the network administrator to gauge the amount of network connections a particular source address is generating. If anomalous, the network infrastructure device port to which the particular attached function associated with that source address is connected to the network system may be assigned a changed policy restricting input in response to the anomaly.

The destination address monitor sub-function is a monitor function that examines only the flows through the network system sent from a network system device to a specific attached function. The flow types associated with the destination address monitor sub-function with reference to FIG. 4 are preferably classified in either of two ways; first, by ingress port and destination address, and second by system-wide aggregation. In respect of the first destination address monitor option for the connection arrangement of FIG. 4, port 301 has one flow, Flow 1, for the destination address of attached function B, port 302 has one flow, Flow 2, for the destination address of attached function C, and port 303 has one flow, Flow 3, for the destination address of attached function C. In respect of the second destination address monitor option, there is one destination address based flow for attached function B, Flow 1, and a set of two destination address based flows for attached function C, Flows 2 and 3.

There are multiple uses of a destination address monitor sub-function in a network system using IPv4. The destination address monitor sub-function may be used to detect port scans of a specified system, virus initiated attacks (such as SQL-Slammer), network ICMP spray attacks or distributed DOS attacks targeting the attached function specified by the destination address.

The bilateral address pair monitor sub-function examines flows based exchanges between two attached functions attached to the network infrastructure. To illustrate the flow types associated with the bilateral address pair monitor sub-function with reference to FIG. 5, a generic network infrastructure device 400 associated with a monitor sub-function module 108a of the module 108, and including attachment ports 401 and 402, is connected to attached functions A and B. Flow 1 represents the transfer of signals from attached function A to attached function B, Flow 2 represents the transfer of signals from attached function B to attached function A, and Flow 3 represents another transfer of signals from attached function A to attached function B. The flows may be classified in terms of the established bilateral pair as a function of transmission direction. Thus, for signal transfers from attached function A to attached function B, there are two flows, Flows 1 and 3. For signal transfers from attached function B to attached function A, there is only one flow as shown, Flow 2. This monitor sub-function may be used to define the flows based on transfer from source to destination. Alternatively, the flows may be defined by receipts at the destination.

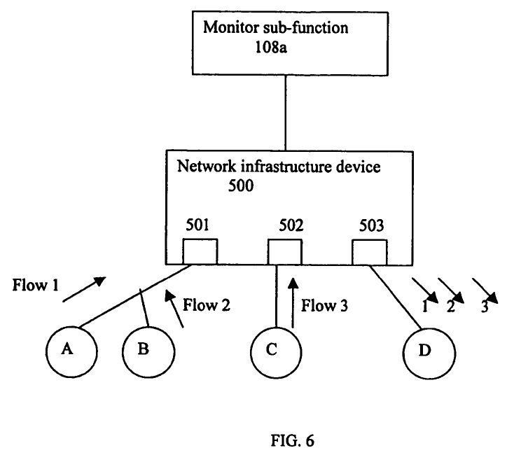

The ingress port monitor sub-function and the egress port monitor sub-function are similar to one another but are independent of source/destination relationships. In particular, each examines flows exchanged through a network infrastructure device based on port activity, whether ingressing or egressing the network infrastructure device. To illustrate the flow types associated with the ingress or egress port monitor sub-function with reference to FIG. 6, a generic network infrastructure device 500 associated with a monitor sub-function module 108a of the module 108, and including ingress ports 501 and 502 and egress port 503, is connected to attached functions A, B, C and D as shown. Flow 1 represents the transfer of signals from attached function A to attached function D, Flow 2 represents the transfer of signals from attached function B to attached function D, and Flow 3 represents the transfer of signals from attached function C to attached function D. The flows may be classified in terms of either ingress flows or egress flows. For ingress flows, there are two flows associated with ingress port 501, Flow 1 from attached function A and Flow 2 from attached function B, and one flow associated with ingress port 502, Flow 3 from attached function C. For egress flows, there are three flows associated with egress port 503, Flows 1-3 to attached function D. The ingress port monitor sub-function monitors flows based only on network infrastructure device ingress port activity, regardless of the attached function identity. The egress port monitor sub-function monitors flows based only on network infrastructure device egress port activity, regardless of the attached function identity.

For each type of flow monitoring sub-function selected, the system of the present invention is further configured to define the monitored flow. In particular, the flow definition sub-function provides a mechanism for identifying the attributes of each flow monitored as part of the detection and mitigation capability. The information associated with the flows monitored may be of considerable detail or of relatively little detail, dependent upon the detection and mitigation needs, as well as the level of capability of the network infrastructure device or devices employed to perform the Detection Function. That is, there are many possible definitions for a flow and different hardware types and packet look up/forward mechanisms may provide monitor flow information with varying degrees of granularity. For instance, a simple OSI Layer 2 based network infrastructure device may be aware of and therefore only able to provide Media Access Control (MAC) addresses and packet types. Alternatively, a basic IPv4 switch/router network infrastructure device may have the ability to classify flows based on IP source/destination address pairs, Class of Service (CoS) value, and IP packet type. An advanced IPv4 switch/router network infrastructure device may have the ability to examine packets based on IP source/destination address pairs, CoS value, IP packet type, and Transmission Control Protocol (TCP), User Datagram Protocol (UDP), and/or Stream Control Transmission Control Protocol source/destination address ports. Moreover, it is contemplated that higher level network infrastructure devices will examine flows based on individual TCP sessions.

While there may be a great many flow definitions possible, in general, it appears that several may be of use to cover most flow cases of interest. Table 1 below sets out examples of suitable flow definitions; however, it is to be understood that other flow definitions may include more or less of the information associated with these preferred ones.

TABLE 1

| Flow Definition | Flow Information |
|---|---|
| OSI Layer 2 Information Set 1 | Source MAC address, Destination MAC |
| | address, MAC packet type |
| OSI Layer 2 Information Set 2 | Source Port identifier, Destination MAC |
| | address |
| OSI Layer 2 Information Set 3 | Source MAC address, Source Port identifier, |
| | MAC Packet type |
| OSI Layer 2 Information Set 4 | Source MAC address, Destination MAC |
| | address, IEEE 802.1Q VLAN Tag, MAC |
| | Packet type |
| OSI Layer 2 Information Set 5 | Source MAC address, Destination MAC |
| | address; IEEE 802.1AD Provider Tag, IEEE |
| | 802.1Q VLAN Tag, MAC Packet type |
| OSI Layer 2 Information Set 6 | Any combination of the above Flow |
| | Information fields or other defined L2 fields |
| OSI Layer 3 Information Set 1 | Source IPv4 address, Destination IPv4 address |
| OSI Layer 3 Information Set 2 | Source IPv4 address, Destination IPv4 address, |
| | IP packet type, CoS value |
| OSI Layer 3 Information Set 3 | Source IPv6 address, Destination IPv6 address, |
| | Flow label value, Type of Service (ToS) value, |
| | and Next field value |
| OSI Layer 3 Information Set 4 | Source Port identifier, Destination IPv4 |
| | address |
| OSI Layer 3 Information Set 5 | Source IPv6 address, Destination IPv6 address |
| OSI Layer 3 Information Set 6 | Source Port identifier, Destination IPv6 |
| | address |
| OSI Layer 3 Information Set 7 | Source Novell IPX address, Destination Novell |
| | IPX address |
| OSI Layer 3 Information Set 8 | Other combinations and other header fields, as |
| | selected by the administrator |
| OSI Layer 4 Information Set 1 | Source IPv4 address, Destination IPv4 address, |
| | IP packet type, CoS value, Source |
| | TCP/UDP/SCTP port, Destination |
| | TCP/UDP/SCTP port |
| OSI Layer 4 Information Set 2 | Source IPv6 address, Destination IPv6 address, |
| | Flow label value, ToS value, Next field value, |
| | Source TCP/UDP/SCTP port, Destination |
| | TCP/UDP/SCTP port |
| OSI Layer 4 Information Set 3 | Combination of all L2, L3, L4 fields as defined |
| OSI Layer 4 Information Set 3 | Other combinations and other header fields, as |
| | selected by the administrator |
| OSI Layer 2 to Layer 4 Information Set 1 | Source MAC address, Destination MAC |
| | address, Source IPv4 address, Destination IPv4 |
| | address, IP packet type, CoS value, Source |
| | TCP/UDP/SCTP port, Destination |
| | TCP/UDP/SCTP port |
| OSI Layer 2 to Layer 4 Information Set 2 | Source MAC address, Destination MAC |
| | address, Source IPv4/IPv6 address, Destination |
| | IPv4/IPv6 address |

The flow definition sub-function allows the network administrator to define the logical constructs or patterns that constitute the flows to be monitored. Further, multiple flow definitions may be used for each flow under monitor and each flow definition may encompass multiple flows under monitor. As an example, the network administrator may be interested in tracking both IPv4 and IPv6 flows at the ingress port of a network infrastructure device. As another example, the administrator may establish a flow definition to be tracked on a per port, per source address, destination address of bi-lateral address pair. Flow definitions may be structured to allow the network administrator to match packets with high or low granularity. An example of a high granularity (much detail) monitor sub-function/flow definition sub-function set would involve tracking flows based on ingress port, egress port, source address, destination address or bilateral address pair. An example of a low granularity (less detail) monitor sub-function/flow definition sub-function set would involve tracking of all new IPv4 flows from an attached function to any destination IPv4 address with any IPv4 packet type, with any ToS value, to and from any source/destination port. Further, the network administrator may set fine grain flow definitions to be matched against particular monitor sub-functions. As an example the administrator might only monitoring traffic to a destination IPv4 address only for Hyper Text Transfer Protocol (HTTP) (destination port 80).

The monitor counter sub-function of the system of the present invention provides a mechanism for gathering information to be acted upon through the Response Function related to the flows under monitor as defined. The monitor counter sub-function is configured to record the occurrences of flow creation as well as the number of active flows for a specific flow definition. The network administrator may establish information collection parameters of interest for each flow definition. The monitor counter sub-function may be a simple counter mechanism that increments with each new flow creation or a group of counters that includes details on active flows, peak and average flow creation rates as well as historical data. The network administrator may select what counters are implemented on a per flow-monitoring basis. The information may be retained locally or remotely, persistently or temporarily.

While there may be a great many counter formats of use, in general, it appears that several may be of use to cover most flow metric cases of interest. Table 2 below sets out examples of suitable flow metrics and counters; however, it is to be understood that other flow metrics and counters may include more or less of the information associated with these preferred ones.

TABLE 2

| Flow Metric | | Information |
|---|---|---|
| Active Flow counter | | Corresponds to number of flows active per |
| per port | | flow definition for a particular monitoring. |
| per trunk | | This value is dynamically incremented or |
| per device | | decremented as flows are aged out or the |
| per (address) | | monitoring system detects that they have ended |
| | | through some other mechanism. |
| Historical Flows counter | | Corresponds to number of new flows created |
| | | by the function since the initialization of the |
| | | Metrics sub-function with a specific flow |
| | | definition. |
| New Flow Creation Rate | | Corresponds to the current rate of new flow |
| Per defined time interval | | creations as detected by metrics sub-function |
| Peak | | with a specific flow definition. The value is |
| Average | | defined in relation to a time interval that is |
| | | administrator configurable. The default time |
| | | interval may be one second. Multiple |
| | | instances of this Counter can be defined based |
| | | on multiple time intervals for monitoring. |
| Peak New Flow Creation Rate per defined | | Corresponds to the peak rate of new flow |
| time interval counter | | creation as defined by the monitor sub-function |
| | | with a specific flow definition. This value is |
| | | defined in relation to a time interval that is |
| | | operator configurable. The default time |
| | | interval is one second. Multiple instances of |
| | | this Counter can be defined based on multiple |
| | | time intervals for monitoring. |
| Instantaneous Attempted New Flow | | Corresponds to the current attempted rate of |
| Creation Rate per defined time interval | | new flow creations whether successful or |
| counters | | failed. This value is defined in relation to an |
| | | operator configurable time interval with a |
| | | default interval of one second. Multiple |
| | | instances of this Counter can be defined based |
| | | on multiple time intervals for monitoring. |
| Average Attempted New Flow Creation | | Corresponds to the current average attempted |
| Rate per defined time interval counter | | rate of new flow creations whether successful |
| | | or failed. This value is defined in relation to an |
| | | operator configurable time interval with a |
| | | default interval of one second. Multiple |
| | | instances of this Counter can be defined based |
| | | on multiple time intervals for monitoring. |
| Peak Attempted New Flow Creation Rate | | Corresponds to the current peak attempted rate |
| per defined time interval counter | | of new flow creations whether successful or |
| | | failed. This value is defined in relation to an |
| | | operator configurable time interval with a |
| | | default interval of one second. Multiple |
| | | instances of this Counter can be defined based |
| | | on multiple time intervals for monitoring. |
| Instantaneous Failed New Flow Creation | | Corresponds to the current rate of failed new flow |
| Rate per defined time interval counter | | creations whether as defined by the monitor sub- |
| | | function with a specific flow definition. This value |
| | | is defined in relation to a time interval that is |
| | | operator configurable. The default time interval is |
| | | one second. Multiple instances can be defined |
| | | based on multiple time intervals for monitoring. |
| Flows since event | | Any of the flow metrics could be counted or |
| | | provide with statistics since a define network |
| | | event. Failed Flow creation since a network |
| | | link failed might indicate the severity of a |
| | | failure to an administrator. |
| Time since last new flow creation value | | Corresponds to a time stamp associated with |
| | | the creation of the last new flow as defined by |
| | | the monitor sub-function/flow definition pair. |
| Unique Flow statistics | | Corresponds to flow characteristics counters |
| | | selectable by the administrator including, but |
| | | not limited to, average packets per flow, peak |
| | | packets per flow, average bytes per flow, and |
| | | peak bytes per flow. Statistics, defined time |
| | | interval, as well as time since last packet |
| | | received. |
| System-Wide Aggregate Instantaneous, | | Corresponds to system-wide aggregate total for |
| Average, and Peak Counters over defined | | active flows, and attempted and failed new |
| time interval | | flow establishments over a defined interval. |
| Top-Flows Counters | | Corresponds to tracking the top flows or the |
| 1. | Active Flows | port or address of systems that create the |
| 2. | Historical Flows | highest flow values. The administrator may |
| 3. | Instantaneous New Flow | define the number of systems or ports to |
| | Creation Rate | include in a list and which counters to track |
| 4. | Average New Flow Creation | and what statistics to log with each. |
| | Rate | An example of a Top-Flow counter would be |
| 5. | Peak New Flow Creation | “Top-10 Source IP Active Flows” for a counter |
| 6. | Instantaneous Attempted | that tracks the top 10 stations based on the |
| | New Flow Creation Rate | number of active flows along with the |
| 7. | Average Attempted New | respective address. For this example, as flows |
| | Flow Creation rate | per source IP address are created or expire, the |
| 8. | Peak Attempted New Flow | ranking per system may change. |
| | Creation Rate | |
| 9. | Instantaneous Failed New | |
| | Flow Creation Rate | |
| 10. | Average Failed New Flow | |
| | Creation Rate | |
| 11. | Peak Failed New Flow | |
| | Creation Rate per defined | |
| | interval. | |

It is further contemplated that in network systems including available information processing resources, the network administrator may further gather information referred to as Time stamp of last new flow creation value, corresponding to a time stamp associated with the creation of the last new flow as defined by the monitor sub-function/flow definition sub-function pair. Additionally, Unique flow statistics may be gathered, preferably including: a) average packets per defined time interval counter; b) peak packets per define time interval counter; c) average bytes per time interval counter; d) peak bytes per time interval counter; and e) time since last packet received counter. These statistics may be maintained for each unique flow. The default time interval is one second, although an operator can define other values. Further, the administrator may configure the system to generate System-wide aggregate instantaneous, average and peak counters over defined time intervals, corresponding to the system-wide aggregate total for active flows, attempted and failed new flow establishments over the operator define time interval.

The information acquired through the various counters provided by the monitor counter sub-function may be compared to known, expected or threshold information. That comparison forms the basis for determining whether an anomaly or flow metric event has been detected in the network system.

The Analysis Function executes based on information parameters established by the network administrator. A response is triggered by matching predefined or dynamically derived values that can be compared values instrumented by the monitor counter sub-function. The Analysis Function compares statistics from multiple monitor counter sub-functions and uses mathematical and logical operations to produce test values. When test criteria have been validated, a response may be initiated. Evaluated statistics may be monitored from local or remote storage or a combination of the two. In general then, the event detection capabilities of the system of the present invention are derived comparing values and the Analysis Function may correlate multiple events.

In the preferred embodiment of the present invention there are two classes of responses; basic and advanced. Basic responses are provided by the DRS and provide a simple method to react to conditions in the data communications device or system and are based on administrator-defined values. Basic triggers can be defined based on the following two mechanisms:

1.) Threshold Exceed over a defined time interval trigger function:
This trigger function is the simplest mechanism. It allows the network administrator to define a value to be tested against one of the monitor counter function counters. For example, the Threshold Exceed trigger may be associated with the “Active Attempted Flow Counter” or the “Instantaneous Attempted New Flow Creation Rate per defined time interval counter,” but is not limited to those two counters. This method is a simple “exceed value” comparison mechanism. In this method, the administrator defines a value that is compared to the actual value of the counter function for a defined time interval. When the actual value exceeds the defined “exceed value” for the proscribed time interval, the system will enable a trigger which will enact one of the defined response functions to be described herein. When the actual value falls below the “exceed value” for a defined time interval, the trigger is deactivated. A default time interval value of zero is applied to this threshold which provides for an instantaneous activation or deactivation. The network administrator may choose to require that a particular threshold has been exceeded for a specified time interval or that the observed value has fallen bellow the defined threshold value for a specified time interval before the activation or deactivation of the trigger.

2.) High Water Mark/Low Water Mark Trigger Function
This trigger function operates in a similar manner to the “Threshold Exceed over a defined time interval trigger function” except that the trigger is not deactivated when the observed value has fallen below the defined threshold value. This trigger function requires that the observed value falls below a defined “low water mark” (some count number) that is not equal to a defined “high water mark” (some count number greater than the low water mark count number). As in the Threshold Exceed function, this trigger function can be activated/deactivated immediately if the defined test interval is 0 seconds or at a delayed time based on an administrator-specified test interval.

Advanced triggers are derived from the basic trigger mechanism, but add the ability to compare current multiple observed values, any type of mathematical operation and the ability to utilize logs history and correlation functions based on history, other devices and comparison files of expected operation. They may include other network status or events not related to those of the Detection Function. As previously indicated, examples of these types of triggers are disclosed in the referenced pending application of John Roese et al.

The Response Function of the present invention defines the policies or actions that may be enabled or changed in reaction to a trigger. When an observed activity count falls below a specified triggering value, the action may be disabled or the policy may revert back to its original state. Nevertheless, in some instances the network administrator may wish to override default low water mark conditions to effect a policy change or a modifying action, or to prevent such a change. For that reason, the present invention contemplates permitting the network administrator to remotely disable an action via any of the systems available to configure network infrastructure devices including, but not limited to, Simple Network Management Protocol (SNMP), remote console, terminal session, Web interface, etc.

It is to be understood that there may be an unlimited number of actions or steps that may be enabled in response to a flow metric trigger event. Some examples of particular actions implemented directly, or through policy driven mechanisms, available to the network administrator include:
1. Drop: This action drops the packet identified as including the anomalous information, causing the network system to establish a new flow.
2. Allow: This action allows the system to continue processing the packet even if a defined trigger function had been enabled.
3. Send SNMP Trap: This action sends an SNMP trap when a trigger function had been enabled. When the trigger function has been disabled, the system of the present invention sends a subsequent trap to indicate the change in system status.
4. Log/Syslog: This action logs the event locally to a console or non-volatile storage, and/or log the event to a syslog server to notify operators of the condition and potentially for further forensic analysis with security tools.
5. Delayed Flow Establishment (Flow Dampening): This action provides a response that inhibits systems from potentially effecting the operation of a network, while still allowing service availability, but at a degraded level. In systems that support exact matched based forwarding, the first unknown packet of a flow will need to be analyzed to create a new flow in the system's flow table. The delayed flow establishment action allows the system administrator to enable a “penalty box” where the system continues to establish new flows, but at a much slower rate than is normally possible for flows associated with the various monitor functions. The administrator defines the time interval that it is to take to process the new flow establishments. For example, if the system has an Ingress Port based monitor, with an IPv4 Layer 4 Flow Definition to enable a trigger, this action would then place all new “unknown packets” into a penalty box where the system would evaluate them at a delayed rate defined by the user, thus “dampening flow creation” for that interface.
6. Low Priority Flow Establishment: This action provides a response that will lower the priority of traffic for flow establishment after a trigger event for an offending network entity or interface. In systems that support exact matched based forwarding, the first unknown packet of a flow will be analyzed to create a new flow in the system's flow table. The Low Priority Flow Establishment action lowers the priority for flow establishment for the interface or network entity that caused the trigger function to be enabled. The system also supports the ability to lower the priority of flow establishments for triggers enabled for monitor functions associated with Destination Addresses, Bi-Lateral Address Pairs or Egress Ports. For example, if the system has an Ingress Port based Monitor with an IPv4 Layer 4 Flow Definition to enable a trigger, this action would place all new “unknown packets” from that Ingress Port into a lower priority queue than the rest of the incoming unknown packets in the system, such that those packets, while still being processed, would not impact the flow establishment for all other traffic.
7. Enable Another Detection Template Action: This action allows a system to enable another Detection Function template. The primary application of this action is to allow the system to utilize a simple Monitor Sub-function, and then when a potentially triggering condition arises on the network, enable a more comprehensive Detection Function template that will allow more precise analysis. As an example, the primary Detection Function template may monitor the aggregate flow creation rate for the entire system. Once a threshold is met, the system then enacts a more precise Monitor Sub-function, such as a Source Address Monitor Sub-function.
8. Disable Detection Template Action: This action disables a specific Detection Function template, including the potential to disable the Detection Function template that enabled this Response Function.
9. Enable Remote Response Action: This action allows a system to enable any of the defined responses on a remote system. The Remote System would be configured with a Detection Function template that contained at least one Response Function. The local system communicates with the remote system(s) via a communications sub-function contained within the Response Function. The communications sub-function is described in more detail below. It is to be understood that multiple Detection Function templates may be enabled on multiple remote systems with the triggering of one “Enable Remote Response” action.
10. Disable Remote Response Function: This action allows a system to disable a Response Function on a remote system. The remote system subject to the disabling must be configured with a Detection Function template including at least one Response Function. The local system communicates with the remote system(s) via the communications sub-function. It is to be understood that multiple Detection Function templates may be disabled on multiple remote systems with the triggering of one “Disable Remote Response” action.

11. System History Table Update Action:
This action updates the Response Function's response history sub-function described herein. Multiple Response Functions can be enacted by a response function by defining the specific Response templates in the Detection Function template. It is also possible for a single Response template to contain multiple responses and hence allows for the execution of multiple response actions. It is expected that the network administrator will, at a minimum, enable Logging and SNMP Traps with one of the Filter Response functions.

The present invention supports both local and distributed modes of operation. In its simplest form, the Detection and Response Functions operate on a single communications device with a minimal analysis function. In a distribute mode, there is a communication function that can be utilized by or associated with all sub-functions and functions to distribute various functions, actions and storage beyond the single system. For example, the Response Function may be centralized on another server system.

Other triggering condition detection methods may also be employed in the context of the system and method of the present invention. Multiple Response Functions can be enacted by a single flow metric trigger. It is expected that network administrators will at least enable Logging and SNMP Traps with one or more of the Response Functions. The Response Functions may further include the implementation of static and/or dynamic policy changes as described in the referenced pending application of John Roese et al.

FIG. 1 shows the Detection Function module 108 and the Response function module 109 as components of the devices of the infrastructure 101 for illustration purposes only. The information representing the one or more Detection and/or Response functions associated with a particular network device, or one or more network devices attached to a particular network device, may be preloaded into module 108 or module 109 in the form of a tracking and detection database, or a response database, or a combination of the two. Either database can be the entire particular database of network system 100, or a portion of that database. For example, the portion of the database included in the module 108 of the device can be a portion associated with those connection points applicable to that particular device, such as all of the connection points associated with the ports of a particular network entry device. Module 108 may include a table of anomalies of interest and counter configurations that is an updateable table that changes with additions or deletions of attached functions information, network infrastructure devices information, detected intrusions, and static and dynamic policies. Similarly, module 109 may include a table of policy designations is preferably updateable and may be stored or cached locally and called upon for subsequent sessions based on changes in network system information.

The following is a list of a few possible devices (but not limited to only those devices) that may contain any one or more of the functions described herein: network switches, data switches, WAN and MAN data relay devices, routers, firewalls, gateways, computing devices such as network file servers or dedicated usage servers, management stations, network connected voice over IP/voice over data systems such as hybrid PBXs and VoIP call managers, network layer address configuration/system configuration servers such as enhanced DHCP servers, enhanced Bootstrap Protocol (bootp) servers, IPv6 address auto-discovery enabled routers, and network based authentication servers providing services such as RADIUS, extensible authentication protocol/IEEE 802.1X or others.

As indicated above, in order to distribute templates changes to network infrastructure devices, network system 100 may employ SNMP. The network administrator provisions the policy information of the terminus of a network cable associated with the attached function in the SNMP ifDescr variable (e.g., the ifDescr is a read only attribute, but many systems allow a network operator to “name” a port, which then will be displayed in this field). The module 109 of a network infrastructure device or associated with a network infrastructure device reads the terminus information via the SNMP. In another example MIB parameters may be established or used to obtain and configure the table of information, the intrusion triggers, and the policying options. MIBs may also be employed to populate the table of dynamic and static historical information for storage and/or caching. Telnet with console access or other communications protocols may be employed to configure the detection function template(s) and/or the response function template(s) to one or more network infrastructure devices.

Other variations of the above examples can be implemented. One example variation is that the illustrated processes may include additional steps. Further, the order of the steps illustrated as part of processes is not limited to the order illustrated in their figures, as the steps may be performed in other orders, and one or more steps may be performed in series or in parallel to one or more other steps, or parts thereof.

Additionally, the processes, steps thereof and various examples and variations of these processes and steps, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, Java, Visual Basic, C, or C++, Fortran, Pascal, Eiffel, Basic, COBOL, and the like, or any of a variety of combinations thereof. The computer-readable medium on which such instructions are stored may reside on one or more of the components of system 100 described above and may be distributed across one or more such components.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A method of monitoring flows of a network system and responding to triggering conditions based on the monitoring, the network system including one or more network devices, the method comprising the steps of:
a. monitoring the network system for flow metrics events;
b. analyzing the monitored flow metric events; and
c. generating a response deemed responsive to any analyzed flow metric events determined to require a response.

2. The method as claimed in claim 1 further comprising the step of establishing flow metrics, events and corresponding responses.

3. The method as claimed in claim 1 wherein the responses include dynamic policy changes.

4. The method as claimed in claim 1 further comprising the step of logging flow metrics events.

5. The method as claimed in claim 1 further comprising the step of logging analyses performed and responses generated.

6. The method as claimed in claim 5 further comprising the step of modifying flows and responses based on logged analyses.

7. The method as claimed in claim 1 wherein the step of generating a response includes distributing one or more policy changes to one or more network devices.

8. The method as claimed in claim 1 wherein the step of generating a response includes modifying the flow metrics being monitored.

9. The method as claimed in claim 1 wherein steps a-c are performed by a single network device or by two or more network devices.

10. The method as claimed in claim 9 wherein the network devices are selected from the group consisting of switches, routers, wireless APs, network entry devices, central switching devices, and servers.

11. The method as claimed in claim 1 wherein a flow metric event is based on a flow definition.

12. The method as claimed in claim 11 wherein the flow definition includes Open System Interconnection (OSI) information from any layer of the OSI model.

13. The method as claimed in claim 11 wherein the flow definition includes data based on field definitions within the packets of data.

14. The method as claimed in claim 11 wherein the flow definition includes data field and bit pattern information within the packets of data.

15. The method as claimed in claim 11 wherein the step of analyzing further includes the step of analyzing other information in addition to flow metric events.

16. The method as claimed in claim 1 wherein the flow metrics are selected from a group consisting of an active flows counter, an historical flows counter, a new flow creation rate, a peak new flow creation rate, an instantaneous attempted new flow creation rate, an average attempted new flow creation rate, a peak attempted new flow creation rate, an instantaneous failed new flow creation rate, flows since a defined event, time since last new flow creation, network administrator defined, and system-wide aggregate instantaneous, average and peak, counters.

17. A method of detecting and responding to one or more triggering conditions associated with flows of signal exchanges from or between a plurality of attached functions of a network system, the network system including one or more network devices, the method comprising the steps of:
a. establishing flow definitions;
b. associating each flow definition with a flow counter, wherein the flow counter generates count information for the defined flow;
c. monitoring one or more flows of the network system for the flow definitions; and
d. generating a response when the count information reaches a defined value.

18. The method as claimed in claim 17 wherein the step of monitoring includes monitoring one or more source addresses of one or more network infrastructure devices, one or more attached functions, or a combination of one or more network infrastructure devices and one or more attached functions.

19. The method as claimed in claim 17 wherein the step of monitoring includes monitoring one or more destination addresses of one or more network infrastructure devices, one or more attached functions, or a combination of one or more network infrastructure devices and one or more attached functions.

20. The method as claimed in claim 17 wherein the step of monitoring includes monitoring one or more ingress ports of one or more network infrastructure devices.

21. The method as claimed in claim 17 wherein the step of monitoring includes monitoring one or more egress ports of one or more network infrastructure devices.

22. The method as claimed in claim 17 wherein the step of monitoring includes monitoring bilateral address pairs between two network system devices.

23. A method of tracking flows of signal exchanges via packets between a plurality of attached functions of a network system, identifying one or more triggering conditions associated with the flows, and generating a response, the network system including one or more network infrastructure devices, the method comprising the steps of:
a. establishing a flow definition;
b. monitoring one or more defined flows;
c. associating each flow definition with a flow counter, wherein the flow counter generates count information for the flow definition;
d. defining particular count information as a triggering condition; and
e. upon determining that a triggering condition exists, generating a response by changing one or more policies associated with one or more network infrastructure devices, one or more attached functions, or both.

24. The method as claimed in claim 23 wherein the response triggering condition is count information generated by the flow counter exceeding a defined value.

25. The method as claimed in claim 24 wherein the response is deactivated when the count information value falls below the defined value.

26. The method as claimed in claim 24 wherein the response is deactivated when the count information value falls below a second defined value that is below the defined value.

27. The method as claimed in claim 23 wherein the response triggering condition is count information generated by a first flow counter reaching a first defined value and count information generated by a second flow counter reaching a second defined value.

28. The method as claimed in claim 23 wherein the triggering condition is count information generated by a first flow counter reaching a first defined value and after determining that the first defined value has been reached, determining whether count information generated by a second flow counter has reached a second defined value.

29. The method as claimed in claim 23 wherein the step of generating a response includes dropping one or more packets of a monitored flow to force creation of a new flow.

30. The method as claimed in claim 23 wherein the step of generating a response includes sending an SNMP trap.

31. The method as claimed in claim 23 wherein the step of generating a response includes logging the monitored flow with a syslog server.

32. The method as claimed in claim 23 wherein the step of generating a response includes reducing the priority of the monitored flow.

33. The method as claimed in claim 23 wherein the step of generating a response includes disabling the port of entry of the monitored flow.

34. The method as claimed in claim 23 wherein the step of generating a response includes changing one or more policies associated with one or more attached functions, one or more network infrastructure devices, or a combination thereof, associated with the monitored flow by adjusting an access control list, a packet filtering arrangement, or a bandwidth permission.

35. A Detection and Response System (DRS) for tracking flows of signal exchanges via packets from or between a plurality of functions of a network system, identifying one or more triggering conditions associated with the flows, and generating a response to the one or more triggering conditions, the network system including one or more network infrastructure devices, the DRS comprising:
a. a Detection Function for monitoring defined flows associated with the network system, and detecting defined triggering conditions; and
b. a Response Function for responding to triggering conditions defined to require a response and implementing a change of condition of the network system.

36. The DRS as claimed in claim 35 wherein the Detection Function includes a monitor sub-function for monitoring flows based on specific metrics.

37. The DRS as claimed in claim 36 wherein the specified metrics are selected from the group consisting of: source address, destination address, ingress port, egress port, and bilateral address pair.

38. The DRS as claimed in claim 35 wherein the Detection Function includes a flow definition sub-function for defining other information associated with a monitored flow.

39. The DRS as claimed in claim 38 wherein the information associated with a monitored flow is selected from the group consisting of: any layer of the OSI model.

40. The DRS as claimed in claim 35 further comprising an Analysis Function for analyzing detected triggering conditions and identifying the response to generate.

41. The DRS as claimed in claim 40 wherein the Detection Function, the Analysis Function, and the Response Function are embodied in a plurality of network devices, the DRS further comprising means for the plurality of devices to communicate.

42. The DRS as claimed in claim 35 wherein the Detection Function includes and uses other network status, data or information, in addition to the defined flow to create a triggering condition.

43. The DRS as claimed in claim 42 wherein the data or information includes time based information.

44. The DRS as claimed in claim 35 wherein the response function initiates a change in operation upon detection by the Detection Function of a monitored flow having activity exceeding a first defined threshold value over a defined time interval and the Response Function deactivating the change upon the monitored flow activity reaching a second defined threshold value less than the first defined threshold value.

45. The DRS as claimed in claim 35 wherein the Response Function initiates an action in response to a trigger from the Detection Function, the action selected from the group consisting of: drop one or more packets, allow one or more packets to be processed, send an SNMP trap, log the activity causing initiation of the trigger, delay the flow, reduce the priority of the flow, and initiate a defined policy change.

46. A Detection and Response System (DRS) for tracking flows of signal exchanges via packets between a plurality of attached functions of a network system, identifying one or more triggering conditions associated with the flows, and generating a response, the network system including one or more network infrastructure devices, the DRS comprising:
a. a flow definition sub-function for defining activity types to be monitored;
b. a monitor sub-function for monitoring flows associated with the network system;
c. a monitor counter sub-function for counting the defined activity types; and
d. a response function for initiating a response in the network system to a monitored flow based on a count of a defined activity type.

47. A method of detecting one or more triggering conditions associated with flows of signal exchanges between a plurality of attached functions of a network system and responding thereto, the network system including one or more network infrastructure devices, the method comprising the steps of:
a. establishing for the one or more network infrastructure devices a flow definition for each flow monitored;
b. monitoring each defined flow of the network system;
c. associating each flow definition with a flow counter, wherein the flow counter generates count information for the flow definition;
d. analyzing the count information;
e. determining whether the analyzed count information indicates a triggering condition requiring a response; and
f. responding to the triggering condition through modification of the operation of the one or more network infrastructure devices.

48. The method as claimed in claim 47 further comprising the step of storing the count information locally.

49. The method as claimed in claim 47 further comprising the step of storing the count information remotely.

50. The method as claimed in claim 47 further comprising the step of enacting the response to the detected triggering condition locally on one or more of the network infrastructure devices associated with the monitored flow, or remotely by one or more devices not associated with the monitored flow.

51. The method as claimed in claim 47 wherein the step of monitoring is performed by a plurality of network infrastructure devices.

52. The method as claimed in claim 47 wherein the step of analyzing is performed concurrently for a plurality of flows under monitor.

53. The method as claimed in claim 47 further comprising the step of initiating one or more additional analyses based on the first analysis of the count information, past stored analysis information, or a combination of the two.

54. The method as claimed in claim 47 wherein the responses that may be enabled under the step of responding may be disabled to allow a flow condition to remain in effect that would otherwise be blocked.

55. The method as claimed in claim 54 wherein the step of analyzing includes the step of analyzing historical counter information and determining based on that historical counter information whether to block the disabling of the flow condition block.
